(19) United States
(12) Patent Application Publication
(10) Pub. No.: US 2020/0296162 A1
(43) Pub. Date: Sep. 17, 2020

(54) DISTRIBUTED STORAGE METHOD AND APPARATUS FOR TRAVEL TIME TABLES

(71) Applicant: BEIJING ANXIN YIDE TECHNOLOGY CO., LTD., BEIJING (CN)

(72) Inventor: XIAOLONG TONG, BEIJING (CN)

(21) Appl. No.: 16/444,817

(22) Filed: Jun. 18, 2019

(30) Foreign Application Priority Data
Mar. 11, 2019 (CN) 201910179871.7

(51) Int. Cl. H04L 29/08; G06F 16/22; G06F 16/903; G06F 16/901

(52) U.S. Cl. CPC H04L 67/1097; G06F 16/901; G06F 16/903; G06F 16/2282

(57) ABSTRACT

Embodiments of the disclosure relate to distributed storage methods and apparatus for travel time tables. One method includes determining a quantity of server sides, determining a server side from all server sides as a primary server side, storing travel time tables corresponding to any seismic work area grids at each moment or travel time tables corresponding to multiple seismic work area grids at each moment, establishing a travel time table storage index in real time according to identifiers of the travel time tables corresponding to the any seismic work area grids at each moment or identifiers of the travel time tables corresponding to the multiple seismic work area grids at each moment, and storing the travel time table storage index in the primary server side.

### CROSS REFERENCE TO RELATED APPLICATIONS

This application claims priority to Chinese application number 20191017987-1.7 filed on Mar. 11, 2019, the disclosure of which is incorporated by reference herein in its entirety.

### FIELD OF THE DISCLOSURE

The disclosure relates generally to the field of geophysical imaging technologies. More specifically, the disclosure relates to the field of a distributed storage method and apparatus for travel time tables.

### BACKGROUND

Kirchhoff depth migration is a key method of geophysical imaging, and includes two steps: travel time calculation and integral imaging. Travel time information generated by travel time computing is stored, and the stored travel time information is referred to as a travel time table. Because a volume of data in a travel time table is excessively large, in a conventional computing method, after thinning and transform coding are performed on the travel time table, the volume of the data in the travel time table can be reduced by 10,000 times or tens of thousands of times, but a volume of data in a travel time table in a large seismic work area is still large. For example, the volume of the data in the travel time table is still more than 1 T.

A current technical solution is to store all travel time tables in a magnetic disk. In a subsequent integral imaging process, because the travel time tables need to be frequently accessed, the magnetic disk needs to be frequently accessed, so that the travel time tables stored in the magnetic disk are stored in a memory in batches. As a result, in the integral imaging process, frequent access to the magnetic disk is performed most of the time, and computing efficiency is greatly reduced.

### SUMMARY

The following presents a simplified summary of the invention in order to provide a basic understanding of some aspects of the invention. This summary is not an extensive overview of the invention. It is not intended to identify critical elements or to delineate the scope of the invention. Its sole purpose is to present some concepts of the invention in a simplified form as a prelude to the more detailed description that is presented elsewhere.

Some exemplary embodiments of the disclosure provide a distributed storage method and apparatus for travel time tables.

According to an embodiment, the disclosure provides a distributed storage method for travel time tables including the following steps. (A) Determining a quantity of server sides, where any server side pre-creates a cache used for storing a travel time table. (B) Determining a server side from all server sides as a primary server side according to a preset rule. (C) Storing travel time tables corresponding to any seismic work area grids at each moment or travel time tables corresponding to multiple seismic work area grids at each moment in caches of server sides in real time by a preset algorithm. (D) Establishing a travel time table storage index in real time according to identifiers of the travel time tables corresponding to the any seismic work area grids at each moment or identifiers of the travel time tables corresponding to the multiple seismic work area grids at each moment, and identifiers of the server sides that store the travel time tables. (E) Storing the travel time table storage index in the primary server side, wherein the identifiers of the travel time tables corresponding to the any seismic work area grids at each moment or the identifiers of the travel time tables corresponding to the multiple seismic work area grids at each moment are in one-to-one correspondence with the identifiers of the server sides that store the travel time tables in the travel time table storage index.

According to another embodiment, the determining a server side from all server sides as a primary server side according to a preset rule further includes randomly determining a server side from all the server sides as the primary server side.

According to a further embodiment, the determining a server side from all server sides as a primary server side according to a preset rule further includes determining a server side from all the server sides as the primary server side according to a preset service requirement.

According to one embodiment, the determining a server side from all server sides as a primary server side according to a preset rule further includes determining a server side from all the server sides as the primary server side according to a server side hardware configuration.

In some embodiments, the storing travel time tables corresponding to any seismic work area grids at each moment or travel time tables corresponding to multiple seismic work area grids at each moment further includes randomly storing the travel time tables corresponding to the any seismic work area grids at each moment or the travel time tables corresponding to the multiple seismic work area grids at each moment in caches of server sides in real time by a preset algorithm.

In other embodiments, the storing travel time tables corresponding to any seismic work area grids at each moment or travel time tables corresponding to multiple seismic work area grids at each moment further includes storing the travel time tables corresponding to the any seismic work area grids at each moment or the travel time tables corresponding to the multiple seismic work area grids at each moment in caches of server sides in real time in a polling manner by a preset polling algorithm.

In further embodiments, the storing travel time tables corresponding to any seismic work area grids at each moment or travel time tables corresponding to multiple seismic work area grids at each moment in caches of server sides in real time by a preset algorithm further includes storing the travel time tables corresponding to the any seismic work area grids at each moment or the travel time tables corresponding to the multiple seismic work area grids at each moment in caches of server sides in real time by a preset travel time table storage configuration.

According to an embodiment, the method further includes: when a target travel time table needs to be obtained, querying the travel time table storage index from the primary server side according to an identifier of the target travel time table, to determine a target server side that stores the target travel time table; and obtaining the target travel time table from the target server side.

According to another embodiment, the disclosure provides a distributed storage apparatus for travel time tables, where the apparatus includes a server side quantity determining module, a primary server side determining module, a travel time table storage module, a storage index establishment module, and a storage index storage module. The server side quantity determining module is configured to determine a quantity of server sides, where any server side pre-creates a cache used for storing a travel time table. The primary server side determining module is configured to determine a server side from all server sides as a primary server side according to a preset rule. The travel time table storage module is configured to store travel time tables corresponding to any seismic work area grids at each moment or travel time tables corresponding to multiple seismic work area grids at each moment in caches of server sides in real time by a preset algorithm. The storage index establishment module is configured to establish a travel time table storage index in real time according to identifiers of the travel time tables corresponding to the any seismic work area grids at each moment or identifiers of the travel time tables corresponding to the multiple seismic work area grids at each moment, and identifiers of the server sides that store the travel time tables. The storage index storage module is configured to store the travel time table storage index in the primary server side. The identifiers of the travel time tables correspond to the any seismic work area grids at each moment or the identifiers of the travel time tables corresponding to the multiple seismic work area grids at each moment are in one-to-one correspondence with the identifiers of the server sides that store the travel time tables in the travel time table storage index.

According to a further embodiment, the primary server side determining module is configured to randomly determine a server side from all the server sides as the primary server side.

Some embodiments of the present disclosure may have one or more of the following effects: through distributed storage, travel time tables may be stored in caches of multiple server sides in a distributed manner, so that in a subsequent integral imaging process, the travel time tables may be highly accessed, which may avoid frequent access to a magnetic disk and improve computing efficiency.

### BRIEF DESCRIPTION OF THE DRAWINGS

FIG. 1 is a schematic diagram of an example application scenario according to an example embodiment of this application.

FIG. 2 is a schematic diagram of an implementation process of distributed storage of travel time tables according to an example embodiment of this application.

FIG. 3 is a schematic structural diagram of a distributed storage apparatus for travel time tables according to an example embodiment of this application.

### DETAILED DESCRIPTION

The following describes multiple exemplary embodiments of the disclosure with reference to the accompanying drawings.

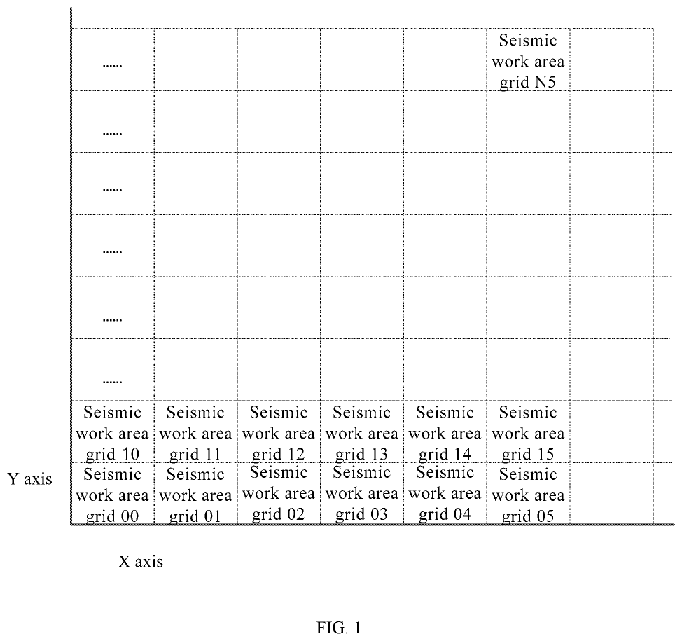

FIG. 1 is a schematic diagram of an example application scenario. In the schematic diagram (Z axis is not shown) of the application scenario shown in FIG. 1, there are multiple seismic work area grids, and any seismic work area grid is corresponding to geographic space in an actual geodetic coordinate system. Because a volume of data in travel time tables corresponding to any seismic work area grids is excessively large, and a volume of data in travel time tables corresponding to all seismic work area grids is larger, in a conventional computing method, after thinning and transform coding are performed on a travel time table, a volume of data in the travel time table may be reduced by 10,000 times or tens of thousands of times, but a volume of data in a travel time table in a large seismic work area is still large. For example, the volume of the data in the travel time table is still more than 1 T. A technical approach is to store all travel time tables in a magnetic disk. In a subsequent integral imaging process, because the travel time tables need to be frequently accessed, the magnetic disk needs to be frequently accessed, so that the travel time tables stored in the magnetic disk are stored in a memory in batches. As a result, in the integral imaging process, frequent access to the magnetic disk is performed most of the time, and computing efficiency is greatly reduced.

In an embodiment of the disclosure, through distributed storage, travel time tables may be stored in caches of multiple server sides in a distributed manner, so that in a subsequent integral imaging process, the travel time tables may be highly accessed, avoiding frequent access to a magnetic disk and thereby greatly improving computing efficiency.

In another embodiment of the disclosure, a quantity of server sides is determined, where any server side pre-creates a cache used for storing a travel time table; a server side is determined from all server sides as a primary server side according to a preset rule; travel time tables corresponding to any seismic work area grids at each moment or travel time tables corresponding to multiple seismic work area grids at each moment are stored in caches of server sides in real time by a preset algorithm; a travel time table storage index is established in real time according to identifiers of the travel time tables corresponding to the any seismic work area grids at each moment or identifiers of the travel time tables corresponding to the multiple seismic work area grids at each moment, and identifiers of the server sides that store the travel time tables; and the travel time table storage index is stored in the primary server side, wherein the identifiers of the travel time tables corresponding to the any seismic work area grids at each moment or the identifiers of the travel time tables corresponding to the multiple seismic work area grids at each moment is/are in one-to-one correspondence with the identifiers of the server sides that store the travel time tables in the travel time table storage index.

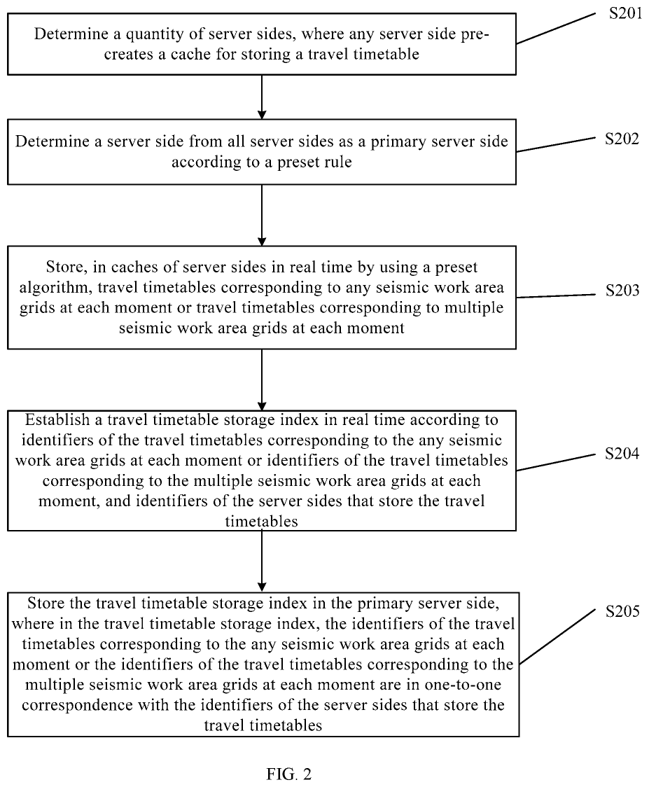

FIG. 2 is a schematic diagram of an implementation process of a distributed storage method for travel time tables in this application. The implementation process may include the following steps.

S201: Determine a quantity of server sides, where any server side pre-creates a cache for storing travel time tables. In some embodiment of the disclosure, travel time tables need to be stored in server sides in a distributed manner, and therefore a quantity of server sides needs to be determined, to facilitate subsequent distributed storage. Any server side pre-creates a cache for storing travel time tables. For example, any server side pre-creates a 5G memory dedicated for storing travel time tables. For example to improve computing efficiency, a server side cluster may be implemented. If the server side cluster includes 10 server sides (that is, servers), a determined quantity of server sides is 10.

S202: Determine a server side from all server sides as a primary server side according to a preset rule. Based on the determined quantity of server sides in S201, for all the server sides, a server side is determined from all the server sides as a primary server side according to a preset rule, and the primary server side further needs to store a travel time table storage index in addition to a travel time table.

According to an embodiment, determining a server side as a primary server side according to a preset rule may be randomly determining a server side from all the server sides as a primary server side. For example, the determined quantity of server sides in S201 is 10, and a server side A is randomly determined from the 10 server sides as the primary server side.

According to another embodiment, determining a server side as a primary server side according to a preset rule may be determining a server side from all the server sides as a primary server side according to a preset service requirement. For example, if the determined quantity of server sides in S201 is 10, and a server side A is pre-specified as a primary server side, the server side A may be specified as the primary server side according to the preset service requirement.

According to a further embodiment, determining a server side as a primary server side according to a preset rule may be determining a server side from all the server sides as a primary server side according to a server side hardware configuration. For example, the determined quantity of server sides in S201 is 10, a hardware configuration status of any server side may be obtained, and a server side with a highest hardware configuration is determined as a primary server side. For example, a server side C has a highest hardware configuration, and the server side C is determined as the primary server side.

S203: Store travel time tables corresponding to any seismic work area grids at each moment or travel time tables corresponding to multiple seismic work area grids at each moment in caches of server sides in real time by a preset algorithm.

The storing travel time tables corresponding to any seismic work area grids at each moment or travel time tables corresponding to multiple seismic work area grids at each moment in caches of server sides in real time by a preset algorithm means that travel time tables may be stored by travel time tables corresponding to any seismic work area grids at each moment as a unit in caches of server sides in real time by a preset algorithm; or travel time tables may be stored by travel time tables corresponding to multiple seismic work area grids at each moment as a unit in caches of server sides in real time by a preset algorithm.

Multiple embodiments may be implemented for storing travel time tables corresponding to any seismic work area grids at each moment or travel time tables corresponding to multiple seismic work area grids at each moment.

In some embodiments, storing travel time tables corresponding to any seismic work area grids at each moment or travel time tables corresponding to multiple seismic work area grids at each moment may be randomly storing the travel time tables corresponding to the any seismic work area grids at each moment or the travel time tables corresponding to the multiple seismic work area grids at each moment in caches of server sides in real time by a preset stochastic algorithm. For example, at a moment 10:00, travel time tables corresponding to a seismic work area grid 00, a seismic work area grid 01, and a seismic work area grid 02 are randomly stored in a cache of a server side A in real time by the preset stochastic algorithm; at the moment 10:00, travel time tables corresponding to a seismic work area grid 10, a seismic work area grid 11, and a seismic work area grid 12 are randomly stored in a cache of a server side C in real time by the preset stochastic algorithm.

In other embodiments, storing travel time tables corresponding to any seismic work area grids at each moment or travel time tables corresponding to multiple seismic work area grids at each moment may be storing the travel time tables corresponding to the any seismic work area grids at each moment or the travel time tables corresponding to the multiple seismic work area grids at each moment in caches of server sides in real time in a polling manner by a preset polling algorithm. For example, at a moment 10:00, travel time tables corresponding to a seismic work area grid 00, a seismic work area grid 01, and a seismic work area grid 02 are stored in a cache of a server side A in real time in a polling manner by a preset polling algorithm; at the moment 10:00, travel time tables corresponding to a seismic work area grid 10, a seismic work area grid 11, and a seismic work area grid 12 are stored in a cache of a server side B in real time in a polling manner by a preset polling algorithm.

In further embodiments, storing travel time tables corresponding to any seismic work area grids at each moment or travel time tables corresponding to multiple seismic work area grids at each moment may be storing the travel time tables corresponding to the any seismic work area grids at each moment or the travel time tables corresponding to the multiple seismic work area grids at each moment in caches of server sides in real time by a preset travel time table storage configuration. For example, travel time tables corresponding to a seismic work area grid 00, a seismic work area grid 01, and a seismic work area grid 02 are stored in a cache of a server side A in a pre-specified manner, and travel time tables corresponding to a seismic work area grid 10, a seismic work area grid 11, and a seismic work area grid 12 are stored in a cache of a server side B in the pre-specified manner. Therefore, a travel time table storage configuration may be obtained. Travel time tables corresponding to multiple seismic work area grids at each moment may be stored in caches of server sides in real time by the preset travel time table storage configuration.

Before distributed storage of travel time tables, the travel time tables may also be compressed, for example, the travel time tables are thinned, transform coding is performed on the travel time tables, the travel time tables are transformed to unsigned integer data, or the like.

For travel time tables, a speed model and seismic work area grid information may be read, and travel time table grid information may be obtained; travel time tables corresponding to any seismic work area grids at each moment may be computed by the speed model, and the travel time tables may be compressed and then stored in a distributed manner.

S204: Establish a travel time table storage index in real time according to identifiers of the travel time tables corresponding to the any seismic work area grids at each moment or identifiers of the travel time tables corresponding to the multiple seismic work area grids at each moment, and identifiers of the server sides that store the travel time tables.

After the travel time tables are stored in the caches of the server sides, the travel time table storage index needs to be established, so that when a travel time table is required subsequently, the travel time table may be obtained from a target server side.

The travel time table storage index may be established in real time according to the identifiers of the travel time tables corresponding to the any seismic work area grids at each moment or the identifiers of the travel time tables corresponding to the multiple seismic work area grids at each moment, and the identifiers of the server sides that store the travel time tables. For example, the identifiers of the travel time tables corresponding to the any seismic work area grids at each moment or the identifiers of the travel time tables corresponding to the multiple seismic work area grids at each moment each are a moment and a seismic work area grid identifier; the identifiers of the server sides that store the travel time tables each may be a name, an IP address, a MAC address, a number, and the like of a server side. The established travel time table storage index is shown in Table 1.

TABLE 1

| Travel time table identifier | Server side identifier |
|---|---|
| 10:00 + 00 | A |
| 10:00 + 01 | B |
| 10:00 + 03 | C |

S205: Store the travel time table storage index in the primary server side, wherein the identifiers of the travel time tables corresponding to the any seismic work area grids at each moment or the identifiers of the travel time tables corresponding to the multiple seismic work area grids at each moment are in one-to-one correspondence with the identifiers of the server sides that store the travel time tables in the travel time table storage index.

For the travel time table storage index established in S204, the travel time table storage index is stored in the primary server side, where the identifiers of the travel time tables corresponding to the any seismic work area grids at each moment or the identifiers of the travel time tables corresponding to the multiple seismic work area grids at each moment are in one-to-one correspondence with the identifiers of the server sides that store the travel time tables, as shown in Table 1.

In a subsequent integral imaging process, when a target travel time table needs to be obtained, the travel time table storage index is queried from the primary server side according to an identifier of the target travel time table to determine a target server side that stores the target travel time table; and the target travel time table is obtained from the target server side. For example, if the identifier of the target travel time table is 10:00+00, the travel time table storage index may be queried from the primary server side to determine that the target server side that stores the target travel time table is a server side A, and the target travel time table is obtained from the server side A.

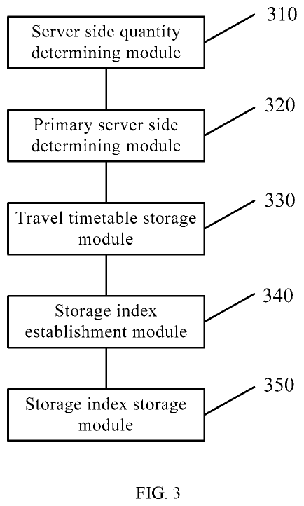

In addition to the distributed storage methods for travel time tables described above, embodiments further provide distributed storage apparatus for travel time tables. Referring to FIG. 3, the apparatus may include a server side quantity determining module 310, a primary server side determining module 320, a travel time table storage module 330, a storage index establishment module 340, and a storage index storage module 350.

The server side quantity determining module 310 is configured to determine a quantity of server sides, where any server side pre-creates a cache used for storing a travel time table.

The primary server side determining module 320 is configured to determine a server side from all server sides as a primary server side according to a preset rule.

The travel time table storage module 330 is configured to store travel time tables corresponding to any seismic work area grids at each moment or travel time tables corresponding to multiple seismic work area grids at each moment in caches of server sides in real time by a preset algorithm.

The storage index establishment module 340 is configured to establish a travel time table storage index in real time according to identifiers of the travel time tables corresponding to the any seismic work area grids at each moment or identifiers of the travel time tables corresponding to the multiple seismic work area grids at each moment, and identifiers of the server sides that store the travel time tables.

The storage index storage module 350 is configured to store the travel time table storage index in the primary server side, wherein the identifiers of the travel time tables corresponding to the any seismic work area grids at each moment or the identifiers of the travel time tables corresponding to the multiple seismic work area grids at each moment are in one-to-one correspondence with the identifiers of the server sides that store the travel time tables in the travel time table storage index.

According to an embodiment of the disclosure, the primary server side determining module 320 is configured to randomly determine a server side from all the server sides as the primary server side.

According to another embodiment of the disclosure, the primary server side determining module 320 is configured to determine a server side from all the server sides as the primary server side according to a preset service requirement.

According to a further embodiment of the disclosure, the primary server side determining module 320 is configured to determine a server side from all the server sides as the primary server side according to a server side hardware configuration.

According to one embodiment of the disclosure, the travel time table storage module 330 is configured to randomly store the travel time tables corresponding to the any seismic work area grids at each moment or the travel time tables corresponding to the multiple seismic work area grids at each moment in caches of server sides in real time by a preset stochastic algorithm.

In some embodiments, the travel time table storage module 330 is configured to store the travel time tables corresponding to the any seismic work area grids at each moment or the travel time tables corresponding to the multiple seismic work area grids at each moment in caches of server sides in real time in a polling manner by a preset polling algorithm.

In other embodiments, the travel time table storage module 330 is configured to store the travel time tables corresponding to the any seismic work area grids at each moment or the travel time tables corresponding to the multiple seismic work area grids at each moment in caches of server sides in real time by a preset travel time table storage configuration.

In further embodiments, the apparatus further includes a travel time table obtaining module 360, configured to: when a target travel time table needs to be obtained, query the travel time table storage index from the primary server side according to an identifier of the target travel time table, to determine a target server side that stores the target travel time table; and obtain the target travel time table from the target server side.

Some embodiments of the present disclosure may have one or more of the following effects: through distributed storage, travel time tables may be stored in caches of multiple server sides in a distributed manner, so that in a subsequent integral imaging process, the travel time tables may be highly accessed, which may avoid frequent access to a magnetic disk and improve computing efficiency.

Persons of ordinary skill in the art may realize that the steps of each method and the units described in the embodiments of the disclosure can be implemented with electronic hardware, computer software, or the combination thereof. In order to clearly describe the interchangeability between the hardware and the software, steps and compositions of each embodiment have been generally described according to functions in the foregoing descriptions. Whether these functions are implemented in hardware or software depends on specific applications of the technical solutions and design constraints. Those skilled in the art may use different methods to implement the described functions for each specific application, but such implementation should not be considered to be beyond the scope of the present application.

The steps of the method or algorithm described in connection with the embodiments disclosed herein may be embodied in hardware, in a software module executed by a processor, or in a combination of both. The software module may be located in a random access memory (RAM) memory, a memory, a read-only memory (ROM), an electrically programmable ROM, an electrically erasable programmable ROM, a register, a hard disk, a removable magnetic disk, a CD-ROM, or a storage medium of any other form known in the technical field.

It should be understood that the foregoing descriptions are merely specific implementations of the present invention, but are not intended to limit the protection scope of the present invention. Any modification, equivalent replacement, or improvement made without departing from the spirit and principle of the present invention should fall within the protection scope of the present invention.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Unless indicated otherwise or inherent, not all steps listed in the various figures need be carried out in the specific order described.

The disclosure claimed is:

1. A distributed storage method for travel time tables, comprising the steps of:
determining a quantity of server sides, wherein any server side pre-creates a cache used for storing a travel time table;
determining a server side as a primary server side according to a preset rule from all server sides;
storing travel time tables corresponding to any seismic work area grids at each moment or travel time tables corresponding to multiple seismic work area grids at each moment in caches of server sides in real time by a preset algorithm;
establishing a travel time table storage index in real time according to identifiers of the travel time tables corresponding to the any seismic work area grids at each moment or identifiers of the travel time tables corresponding to the multiple seismic work area grids at each moment, and identifiers of the server sides that store the travel time tables; and
storing the travel time table storage index in the primary server side, wherein either:
(a) the identifiers of the travel time tables correspond to the any seismic work area grids at each moment are in one-to-one correspondence with the identifiers of the server sides that store the travel time tables in the travel time table storage index; or
(b) the identifiers of the travel time tables correspond to the multiple seismic work area grids at each moment are in one-to-one correspondence with the identifiers of the server sides that store the travel time tables in the travel time table storage index.

2. The method according to claim 1, further comprising:
querying the travel time table storage index from the primary server side according to an identifier of a target travel time table to determine a target server side that stores the target travel time table when a target travel time table needs to be obtained; and
obtaining the target travel time table from the target server side.

3. The method according to claim 1, wherein the determining a server side from all server sides as a primary server side according to a preset rule further comprises randomly determining a server side from all the server sides as the primary server side.

4. The method according to claim 3, further comprising:
querying the travel time table storage index from the primary server side according to an identifier of a target travel time table to determine a target server side that stores the target travel time table when a target travel time table needs to be obtained; and
obtaining the target travel time table from the target server side.

5. The method according to claim 1, wherein the determining a server side from all server sides as a primary server side according to a preset rule further comprises determining a server side from all the server sides as the primary server side according to a preset service requirement.

6. The method according to claim 5, further comprising:
querying the travel time table storage index from the primary server side according to an identifier of a target travel time table to determine a target server side that stores the target travel time table when a target travel time table needs to be obtained; and
obtaining the target travel time table from the target server side.

7. The method according to claim 1, wherein the determining a server side from all server sides as a primary server side according to a preset rule further comprises determining a server side from all the server sides as the primary server side according to a server side hardware configuration.

8. The method according to claim 7, further comprising:
querying the travel time table storage index from the primary server side according to an identifier of a target travel time table to determine a target server side that stores the target travel time table when a target travel time table needs to be obtained; and
obtaining the target travel time table from the target server side.

9. The method according to claim 1, wherein the storing travel time tables corresponding to any seismic work area grids at each moment or travel time tables corresponding to multiple seismic work area grids at each moment further comprises:
randomly storing the travel time tables corresponding to the any seismic work area grids at each moment or the travel time tables corresponding to the multiple seismic work area grids at each moment in caches of server sides in real time by a preset stochastic algorithm.

10. The method according to claim 9, further comprising:
querying the travel time table storage index from the primary server side according to an identifier of a target travel time table to determine a target server side that stores the target travel time table when a target travel time table needs to be obtained; and
obtaining the target travel time table from the target server side.

11. The method according to claim 1, wherein the storing travel time tables corresponding to any seismic work area grids at each moment or travel time tables corresponding to multiple seismic work area grids at each moment further comprises:
storing the travel time tables corresponding to the any seismic work area grids at each moment or the travel time tables corresponding to the multiple seismic work area grids at each moment in caches of server sides in real time in a polling manner by a preset polling algorithm.

12. The method according to claim 11, further comprising:
querying the travel time table storage index from the primary server side according to an identifier of a target travel time table to determine a target server side that stores the target travel time table when a target travel time table needs to be obtained; and
obtaining the target travel time table from the target server side.

13. The method according to claim 1, wherein the storing travel time tables corresponding to any seismic work area grids at each moment or travel time tables corresponding to multiple seismic work area grids at each moment further comprises:
storing the travel time tables corresponding to the any seismic work area grids at each moment or the travel time tables corresponding to the multiple seismic work area grids at each moment in caches of server sides in real time by a preset travel time table storage configuration.

14. The method according to claim 13, further comprising:
querying the travel time table storage index from the primary server side according to an identifier of a target travel time table to determine a target server side that stores the target travel time table when a target travel time table needs to be obtained; and
obtaining the target travel time table from the target server side.

15. A distributed storage apparatus for travel time tables, comprising:
a server side quantity determining module for determining a quantity of server sides, wherein at least one of the server sides pre-creates a cache used for storing a travel time table;
a primary server side determining module for determining a respective server side from all of the server sides as a primary server side according to a preset rule;
a travel time table storage module for storing travel time tables corresponding to any seismic work area grids at each moment or travel time tables corresponding to multiple seismic work area grids at each moment in caches of server sides in real time by a preset algorithm;
a storage index establishment module for establishing a travel time table storage index in real time according to:
(a) identifiers of the server sides that store the travel time tables; and
either:
(b) identifiers of the travel time tables corresponding to the any seismic work area grids at each moment; or
(c) identifiers of the travel time tables corresponding to the multiple seismic work area grids at each moment; and
a storage index storage module for storing the travel time table storage index in the primary server side, wherein either:
(d) the identifiers of the travel time tables corresponding to the any seismic work area grids at each moment are in one-to-one correspondence with the identifiers of the server sides that store the travel time tables in the travel time table storage index; or
(e) the identifiers of the travel time tables corresponding to the multiple seismic work area grids at each moment are in one-to-one correspondence with the identifiers of the server sides that store the travel time tables in the travel time table storage index.

16. The apparatus according to claim 15, wherein the primary server side determining module randomly determines a server side from all the server sides as the primary server side.
